(19) United States
(12) Patent Application Publication
(10) Pub. No.: US 2012/0027489 A1
(43) Pub. Date: Feb. 2, 2012

(54) PRINTER WITH COUPLED MEDIA FEED AND PRINT HEAD ACTIVATION MECHANISM

(76) Inventors: Yaw Horng Yap, Singapore (SG); Shao Hwa Lee, Singapore (SG)

(21) Appl. No.: 12/846,924

(22) Filed: Jul. 30, 2010

(51) Int. Cl. B41J 33/22

(52) U.S. Cl. 400/236.2

(57) ABSTRACT

A printer is disclosed for printing on media. The printer includes a platen roller, a print head, and a media feed roller. The print head is supported by an arm. The arm is actuatable between an activated position in which the print head is urged toward the platen roller to provide a force therebetween and a deactivated position in which the print head is moved away from the platen roller. A motor is coupled to the arm and the media feed roller. The motor selectively actuates the arm between the activated position and the deactivated position and further drives the media feed roller.

### CROSS-REFERENCE TO RELATED APPLICATIONS

Not applicable.

### STATEMENT OF FEDERALLY SPONSORED RESEARCH OR DEVELOPMENT

Not applicable.

### BACKGROUND OF THE INVENTION

This disclosure relates to a printer and, in particular, to a printer having a single gear train that drives various mechanisms of the printer.

Thermal transfer printers for tube media present unique demands in comparison to thermal transfer printers for flat media. As a flat printing surface on the tube media needs to be established, the tube media must be deformed, at least to some degree, during the printing process. In particular, the print media should be flattened proximate the print head and a corresponding platen roller, as it is at this location that the creation of a flat surface for printing is of the greatest importance.

In many tube media printers, the print head itself is used to apply and maintain this force to the tube media. To generate this force on the print head, many tube printers include a long lever connected to the print head that is manually activated by a user. This kind of mechanical lever, however, greatly increases the footprint of the tube printer and requires manual activation by the user. Although automatic print head activation mechanisms have been implemented in some tube printers, these mechanisms frequently complicate the structure of the tube printer and require multiple independent motors which add to the overall cost and maintenance of the system.

Hence, a need exists for an improved printer for tube media. In particular, there is a need for a printer that automatically applies the force necessary for print head activation without significantly increasing the footprint of the printer and, further, without adding significant cost or complexity to the printer.

### SUMMARY OF THE INVENTION

A printer is disclosed for printing on media. The printer includes a platen roller, a print head, and a media feed roller. The print head is supported by an arm. The arm is actuatable between an activated position in which the print head is urged toward the platen roller to provide a force therebetween and a deactivated position in which the print head is moved away from the platen roller. A motor is coupled to the arm and the media feed roller. The motor selectively actuates the arm between the activated position and the deactivated position and further drives the media feed roller.

In many forms of the printer, the motor may be coupled to the arm and the media feed roller by a gear train. The gear train may include a delay gear that initially actuates the arm and, after a delay, drives the media feed roller. The delay gear may be configured to generate a delay having a duration that permits completion of an actuation of the arm before driving the media feed roller.

A rocker arm assembly may operably link the motor to a print head activation gear that actuates the arm. The rocker arm assembly may include a central gear that separately intermeshes with two satellite gears. Further, the rocker arm assembly may be pivotable between a forward feed position and a reverse feed position. In the forward feed position, a first gear of the two satellite gears may drive the print head activation gear to move the arm into the activated position and a second gear of the two satellite gears may engage and drive a ribbon spool. In the reverse feed position, the first gear of the two satellite gears may disengage the print head activation gear and the second gear of the two satellite gears may engage and drive the print head activation gear to move the arm into the deactivated position.

The print head activation gear may include a plurality of radially outward extending teeth located about a circumference of the gear. In one form, at least a portion of the circumference of the print head activation gear may not have teeth. The portion of the circumference of the print head activation gear that does not have teeth may be positioned such that, during activation of the arm, as the arm approaches the activated position, the first gear of the two satellite gears reaches the portion of the circumference of the print head activation gear that does not have teeth. When the first gear reaches this toothless region of the print head activation gear, the first gear may no longer be able to drive the print head activation gear, thereby preventing further forward driving of the print head activation gear by the first gear. Likewise, another toothless portion of the print head activation gear may exist proximate a circumferential region in which the second gear has driven the print head activation gear to a point in which the arm is in the deactivated position.

In some forms, the printer may further include a brake that engages the print head activation gear when the arm approaches the activated position. The print head activation gear may include an outwardly-facing non-toothed surface that engages the brake to maintain the print head activation gear in place. This prevents the portion of the circumference that does not have teeth from slipping and an end tooth on one side of the portion of the circumference does not have teeth from repetitively engaging the first gear of the two satellite gears and generating noise.

In one form of the printer, the rocker arm assembly may further include a stop and the print head activation gear may include an axially-facing lip. In this form, when the rocker arm assembly is moved to the forward feed position and the first gear drives the print head activation gear to actuate the arm to the activated position, the stop on the rocker arm assembly may be configured to engage the axially-facing lip on the print head activation gear. This engagement may maintain the position of an axis of rotation of the first gear of the two satellite gears relative to an axis of rotation of the print head activation gear. This has the effect of maintaining the meshing of the first gear with the print head activation gear.

The print head activation gear may also include a cam surface and the arm may also include a projection that contacts the cam surface. An interaction of the cam surface with the projection during rotation of the print head activation gear may cause actuation of the arm. The cam surface may have a profile that generates a dwell time during activation of the print head toward the platen roller in which the print head is held in position apart from the platen roller before activation is complete. During the dwell time, a ribbon drive may be rotated to take up slack in an ink ribbon.

In some forms, the platen roller of the printer may also be driven by the motor.

A method of operating a printer for printing on tube media is also disclosed. The method includes operating a motor that drives a gear train. An arm supporting a print head is actuated via the gear train. The arm is actuated between an activated position in which the print head is urged toward the platen roller to provide a force therebetween and a deactivated position in which the print head is moved away from the platen roller. A media feed roller is also driven via the gear train.

In one form of the method, a delay gear in the gear train first may drive actuation of the arm and, only after actuation of the arm is complete, does the delay gear in the gear train drive the media feed roller.

Thus, a printer for tube media is provided that both actuates a print head between activated and deactivated positions and, further, drives a media feed roller using a single motor. The functions are timed such that the feed mechanisms may not engage until activation or deactivation of the arm and the attached print head has been completed. The disclosed structure avoids the need for a large mechanical lever to apply print head force, which increases the footprint of the printer and presents usability issues. Moreover, as only a single motor is used to perform both functions, the cost and size of the tube printer is minimized.

These and still other advantages of the invention will be apparent from the detailed description and drawings. What follows is merely a description of a preferred embodiment of the present invention. To assess the full scope of the invention, the claims should be looked to as the preferred embodiment is not intended to be the only embodiment within the scope of the claims.

### BRIEF DESCRIPTION OF THE DRAWINGS

FIG. 1 is a top side perspective view of a tube printer with the top cover removed;

FIG. 2 is a perspective view of a portion of the innards of the tube printer including a gear train and an arm that supports a print head;

FIGS. 3 through 7 are side views of the gear train which illustrate various sequential steps of the activation and deactivation of a print head at the end of the arm;

FIG. 8 is a perspective view of a rocker arm assembly separate from the gear train;

FIG. 9 is a top side perspective view of the print head activation gear illustrating a cam surface; and

FIG. 10 is a bottom side perspective view of the print head activation gear illustrating the axially-facing lip.

### DETAILED DESCRIPTION OF THE PREFERRED EMBODIMENT

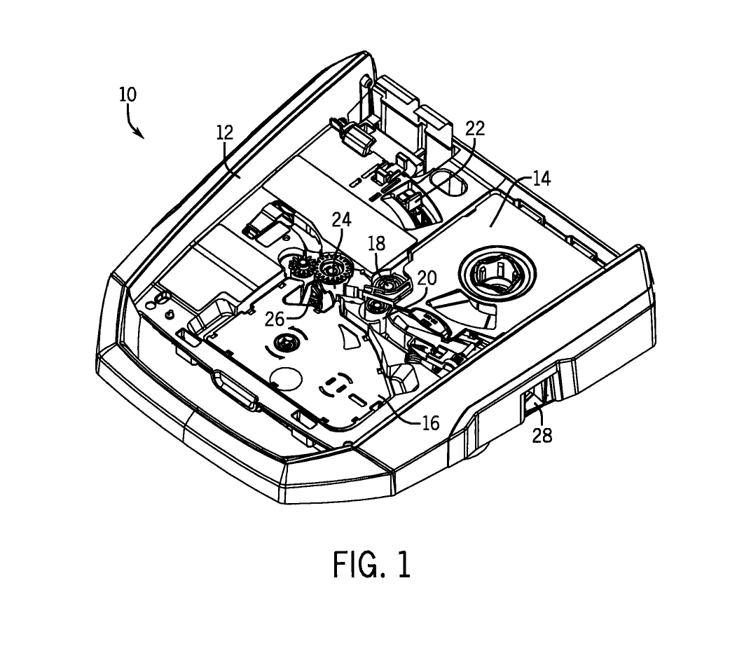

Referring first to FIG. 1, a tube printer 10 is shown for printing on tube media. The tube printer 10 includes a housing 12 that, as illustrated, receives a media cartridge 14 and a ribbon cartridge 16 on either side of a media path for the tube media. Proximate the exit end of the media cartridge 14, a media feed roller 18 and a corresponding pressure roller 20 are positioned to pull the tube media from the media cartridge 14. During loading of the media cartridge 14, the pressure roller 20 may be actuated toward or away from the media feed roller 18 by actuation of a lever 22 which overcomes a biasing force (provided by a spring or the like) that tends to bias the pressure roller 20 toward the media feed roller 18. After the tube media is directed through the media feed roller 18 and the pressure roller 20, the tube media is then fed though an area between a print head 24 and a platen roller 26.

The print head 24 is biased toward the platen roller 26 to apply pressure to the tube media and to pinch the tube media between the print head 24 and the platen roller 26, thereby establishing a flat surface on the tube media for printing. In the form shown, the print head 24 is a thermal print head that heats an ink ribbon that is threaded between the print head 24 and the tube media. By selectively heating and cooling portions of the print head 24, the print head 24 is able to print patterns including, for example, text and images onto the tube media as the tube media is fed through the print head 24 and the platen roller 26.

Although not shown in FIG. 1, the tube printer 10 includes a cutting mechanism or the like downstream of the print head 24. The cutting mechanism is used to sever a length of printed tube media from the length of unprinted tube media.

While FIG. 1 illustrates the placement of a media cartridge 14 within the housing 12 of the tube printer 10, other printing configurations may be used to print on bulk quantities of tube media. For example, to print on tubing from a large spool using the tube printer 10, instead of loading a media cartridge 14 into the housing 12, an end of the tube media may be inserted in a bulk opening 28 on the lateral side of the housing 12. The inserted end of the tube media may then be routed through the media feed roller 18 and the pressure roller 20 and then past the print head 24 and the platen roller 26.

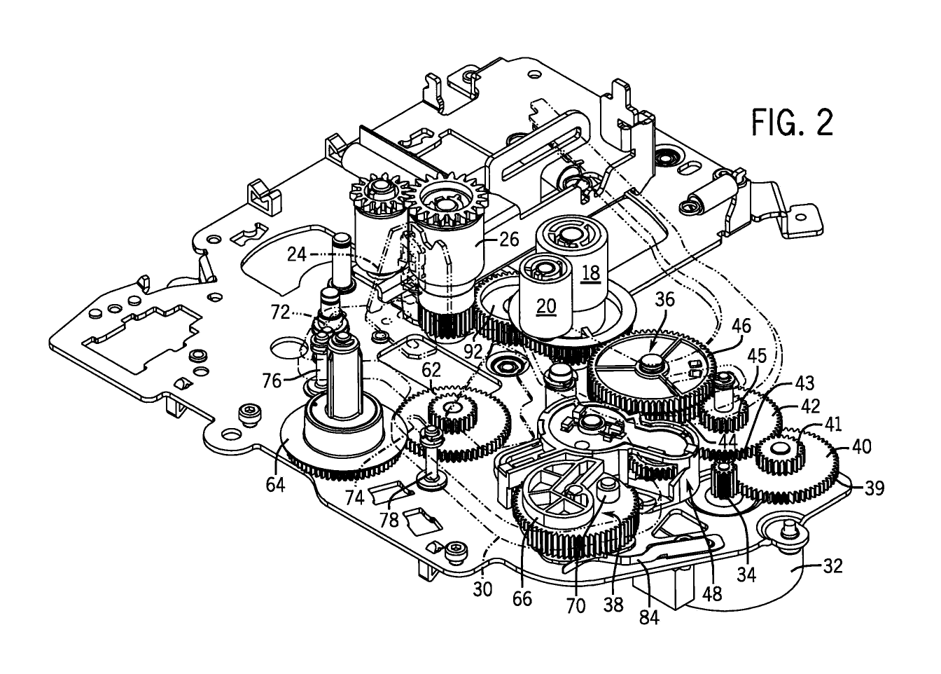

Looking now at FIGS. 2 through 7, a gear train within the tube printer 10 is shown, albeit separate from the tube printer 10 to better display the various gears and components and their interaction with one another.

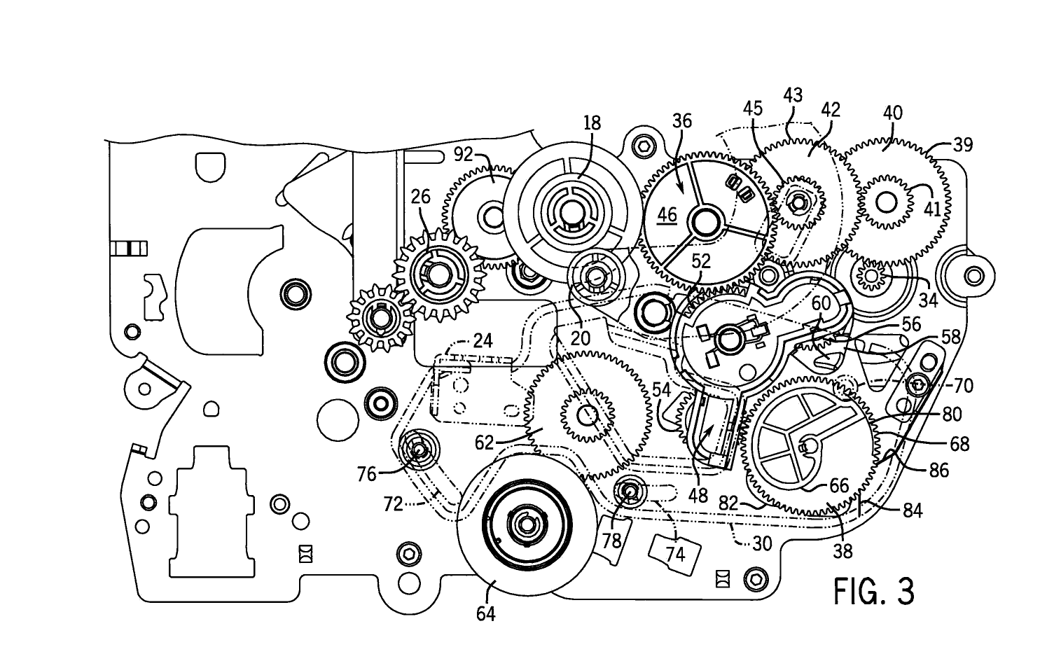

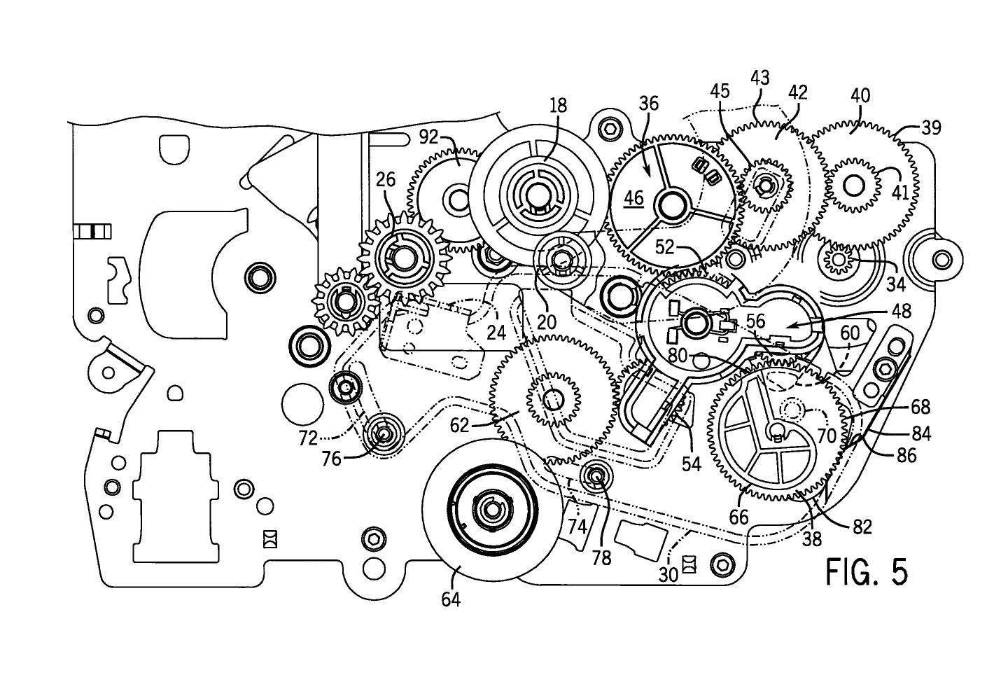

The gear train is constructed to both drive the media feed roller 18 and platen roller 26 as well as activate or deactivate an arm 30 that supports the print head 24 using a single motor 32. In one operational direction of the motor 32, the arm 30 is moved from the deactivated position in which the print head 24 is spaced from the platen roller 26 (as is illustrated in FIG. 3) to the activated position in which the print head 24 is moved toward the platen roller 26 (as is illustrated in FIG. 5) thereby providing a pressure between the print head 24 and the platen roller 26 that pinches the tube media and applies a sufficient pressure for thermal transfer printing. In the forward operational direction, the arm 30 is actuated to the activated position by the gear train and, only after the activation of the arm 30, do the media feed roller 18 and the platen roller 26 begin to rotate. In the reverse operational direction, the arm 30 is moved from the activated position to the deactivated position and, after the arm 30 is deactivated, the media feed roller 18 and platen roller 26 are rotated in a reverse feed direction.

The gear train initially extends from a motor-driven gear 34 which is, as the name indicates, driven by the motor 32 to a delay gear 36. At the delay gear 36, the gear train splits into two legs. A first leg connects the delay gear 36 to a print head activation gear 38 and ribbon feed components. A second leg connects the delay gear 36 to the media feed roller 18 and the platen roller 26. The delay gear 36 is configured to first cause the motor-driven gear 34 to effectuate rotation of the print head activation gear 38 to activate or deactivate the arm 30. Then, after the delay is complete and the arm 30 is actuated, the delay gear 36 drives the media feed roller 18 and the platen roller 26 to feed the tube media in a forward or reverse direction.

The motor-driven gear 34 is coupled to the delay gear 36 by a first idler gear 40 and a second idler gear 42. These idler gears 40 and 42 are each dual layer spur gears. When the motor 32 is operating, the teeth of the motor-driven gear 34 engage the teeth 39 on the layer of the first idler gear 40 having the larger diameter causing the rotation of the first idler gear 40 in a direction opposite the motor-driven gear 34. The teeth 41 of the layer of the first idler gear 40 with the smaller diameter then engage the teeth 43 of the layer of the second idler gear 42 with the larger diameter to cause rotation of the second idler gear 42 in a direction opposite the first idler gear 40, but in the same rotational direction as the motor-driven gear 34. The teeth 45 of the layer of the second idler gear 42 with the smaller diameter then engage a direct-driven portion 44 of the delay gear 36.

In the transfer of motion from the motor-driven gear 34 to the delay gear 36, the above-described configuration of the idler gears 40 and 42 results in a reduction in the speed of the input from the motor-driven gear 34 to the delay gear 36. However, by reduction of the gear speed, an increase in the torque is realized.

As mentioned above, upon driving of the delay gear 36, part of the delay gear 36 immediately drives the leg of the gear train relating to the actuation of the arm 30 and, after a duration, another portion of the delay gear 36 drives the leg of the gear train relating to the rotation of the media feed roller 18 and the platen roller 26. The delay gear 36 has a two-part structure including the above-mentioned direct-driven portion 44 that is driven by the motor 32 via the first and second idler gears 40 and 42 and a delayed portion 46 that will rotate with the direct-driven portion 44 after a predetermined amount of angular rotation of the direct-driven portion 44. The direct-driven portion 44 and the delayed portion 46 have axes of rotation that are coaxial with one another and diameters that are equal to one another.

To create the delay, the axial faces of the direct-driven portion 44 and the delayed portion 46 that face one another have features that interact with one another, such as projections, tabs, and so forth. When the direct-driven portion 44 of the delay gear 36 is rotated, it will require some amount of angular rotation before the features on the axial faces interact with one another to cause the delayed portion 46 to begin rotating with the direct-driven portion 44. When the direction of rotation of the direct-driven portion 44 is reversed, then the features on the axially facing surfaces will disengage one another and the delayed portion 46 will again not be driven until the direct-driven portion 44 of the delay gear 36 re-engages the delayed portion 46 after some amount of rotation in the other angular direction of rotation. It should be appreciated that the features of the delay gear 36 that interact between the direct-driven portion 44 and the delayed portion 46 need not necessarily be formed on the axial faces of the portions. For example, a projection on one of the portions could engage a slot extending through at least a segment of the other portion.

The teeth of the direct-driven portion 44 of the delay gear 36 also drive a rocker arm assembly 48. As will be described in further detail below, the rocker arm assembly 48 pivots between two positions depending on the direction of operation of the motor 32 to selectively actuate the arm 30 and, in at least one of the two positions, drive the ribbon feed components.

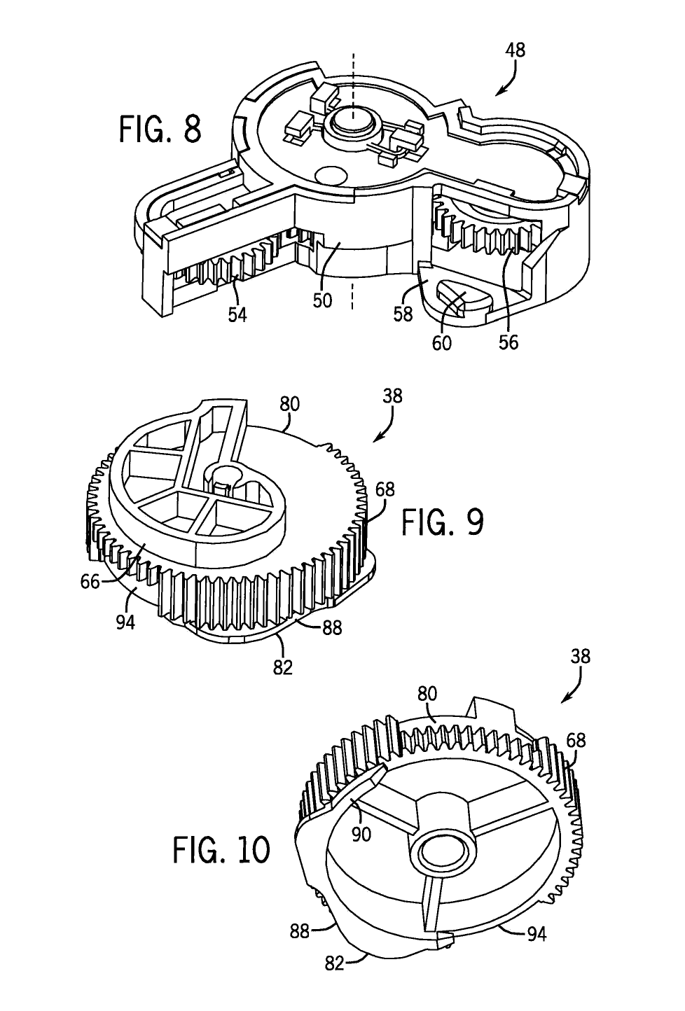

The rocker arm assembly 48 is shown separate from the gear train and in more detail in FIG. 8. The rocker arm assembly 48 includes a bracket 50 that supports a central gear 52 which separately meshes with two satellite gears 54 and 56 about the circumference of the central gear 52 and with the two satellite gears 54 and 56 meshing with the central gear 52 at two different non-overlapping axial heights of the central gear 52. The bracket 50 fixes the position of the rotational axes of the central gear 52 relative to the two satellite gears 54 and 56. The rocker arm assembly 48 is capable of pivoting about the axis of rotation of the central gear 52 such that, when the rocker arm assembly 48 pivots about the axis of the central gear 52, the satellite gears 54 and 56 rotate about the central gear 52.

The bottom portion of the bracket 50 also includes a projection 58 proximate the rightmost satellite gear 56 (as viewed from the perspective of FIGS. 3 through 7). The projection includes an upwardly extending stop 60 which selectively interacts with the print head activation gear 38 as will be described in further detail below.

The rocker arm assembly 48 brings the two satellite gears 54 and 56 into selective engagement with the print head activation gear 38 and a ribbon spool idler gear 62 that is coupled to a ribbon drive 64. The engagement of the two satellite gears 54 and 56 with the print head activation gear 38 and the ribbon spool idler gear 62 depends on the pivotal position of the rocker arm assembly 48.

To change the pivotal position of the rocker arm assembly 48, the direct-driven portion 44 of the delay gear 36 drives the central gear 52 of the rocker arm assembly 48. When the central gear 52 rotates, this can initially cause the rocker arm assembly 48 to pivot (depending on the initial position of the rocker arm assembly and the direction of rotation). When pivoted to one of its extremes, any additional rotation of the central gear 52 is then transmitted to the two satellite gears 54 and 56 to drive the rotation of the teeth of the two satellite gears 54 and 56.

The rocker arm assembly 48 is pivotable between two positions, a forward feed position and a reverse feed position, which are both restricted by the locations of surrounding gears. In the forward feed position in which the rocker arm assembly 48 has been rotated clockwise, the rightmost satellite gear 56 engages the print head activation gear 38 while the leftmost satellite gear 54 engages the ribbon spool idler gear 62. In the reverse feed position in which the rocker arm assembly 48 has been rotated counter-clockwise, the leftmost satellite gear 54 engages the print head activation gear 38 while the rightmost satellite gear 56 is cleared from engagement with other gears (except for the central gear 52 to which it is attached by the bracket 50).

When the motor-driven gear 34 is driven in the forward direction (which is the clockwise direction as viewed from the perspective of FIGS. 3 through 7), this causes the central gear 52 to rotate clockwise, thereby pivoting the rocker arm assembly 48 to the forward feed position. In the forward feed position, the continued clockwise rotation of the central gear 52 causes the counter-clockwise rotation of the two satellite gears 54 and 56, which results in the clockwise rotation of the print head activation gear 38 as well as the clockwise rotation of the ribbon spool idler gear 62 and the counter clockwise rotation of the ribbon drive 64.

Conversely, when the motor-driven gear 34 is driven in a reverse direction (which is the counter-clockwise direction), this causes the central gear 52 to rotate counter-clockwise, thereby pivoting the rocker arm assembly 48 to the reverse feed position. After pivoting, the counter-clockwise rotation of the central gear 52 causes the clockwise rotation of the two satellite gears 54 and 56. After pivoting to the reverse position, the leftmost satellite gear 54 contacts and drives another the print head activation gear 38 in a counter-clockwise direction. Although the central gear 52 continues to drive the rightmost satellite gear 56, the rightmost satellite gear 56 does not mesh with any other gears as it has been swung away from the print head activation gear 38 and, accordingly, does not drive any other gears.

Referring now to FIGS. 9 and 10, the print head activation gear 38 is shown in more detail. On the top side of the print head activation gear 38, a cam surface 66 is formed. This cam surface 66 protrudes from the axial surface of the print head activation gear 38 and forms a curved surface that extends from approximately the rotational center of the print head activation gear 38 to approximately an outer circumference 68 of the print head activation gear 38.

This cam surface 66 engages a post 70 on the arm 30 to cause the actuation of the arm 30 and the print head 24 between the activated and deactivated positions. As best seen in FIGS. 2 through 7, the arm 30 has two guiding slots 72 and 74 which engage posts 76 and 78, respectively. The two guiding slots 72 and 74 and the posts 76 and 78, define a range of motion for the arm 30 between the activated and deactivated positions along which the arm 30 is translated and rotated. As the print head activation gear 38 rotates, the post 70 of the arm 30 engages the cam surface 66 thereby causing the arm 30 to move within the limits of the guiding slots 72 and 74.

While the print head activation gear 38 has teeth that extend about the outer circumference 68, an angular toothless section 80 of the outer circumference 68 lacks teeth. When the print head activation gear 38 is rotated to the point where the teeth of the rightmost satellite gear 56 reach the angular toothless section 80 of the print head activation gear 38, the print head activation gear 38 no longer is able to be further rotated in that direction as the teeth of the rightmost satellite gear 56 have no teeth to engage on the print head activation gear 38 at this angular orientation, thereby preventing the further rotation of the print head activation gear 38 in that direction. This angular toothless section 80 is positioned such that the print head activation gear 38 does not over-actuate the arm 30 by engagement with the cam surface 66 and excessively jam the print head 24 into the platen roller 26.

The print head activation gear 38 also includes an outwardly-facing non-toothed surface 82 that selectively engages a brake 84 to prevent the teeth of the rightmost satellite gear 56 from continually clipping on the last tooth of the print head activation gear 38. During forward feeding, when the print head activation gear 38 is rotated to a point at which the rightmost satellite gear 56 approaches the angular toothless section 80, the brake 84 engages the outwardly-facing non-toothed surface 82 to maintain the print head activation gear 38 in place, thereby retaining the arm 30 in the activated position.

In the form shown, the brake 84 is a flexible member having a convex surface 86 that faces the print head activation gear 38. The outwardly-facing non-toothed surface 82 of the print head activation gear 38 has a concave surface 88 that generally corresponds to the convex surface 86 of the brake 84. When the print head activation gear 38 is rotated to the point at which the teeth of the rightmost satellite gear 56 are approaching the angular toothless section 80 of the print head activation gear 38, the brake 84 initially flexes outwardly away from the outwardly-facing non-toothed surface 82 of the print head activation gear 38. Upon further rotation, the convex surface 86 of the brake 84 passes a point of maximum deflection away from the outwardly-facing non-toothed surface 82 and then, as the brake 84 attempts to return to a non-deflected state, begins to seat within the concave surface 88 of the outwardly-facing non-toothed surface 82. This eventually forces the rotation of the print head activation gear 38 to a point at which the teeth of the rightmost satellite gear 56 will not engage the last tooth of the print head activation gear 38. Accordingly, the point at which the convex surface 86 of the brake 84 is comfortably seated within the concave surface 88 of the outwardly-facing non-toothed surface 82 corresponds to this point of non-engagement of the rightmost satellite gear 56 and the print head activation gear 38.

Further, looking at the bottom side of the print head activation gear 38 in FIG. 10, an axially-facing lip 90 extends outwardly from the print head activation gear 38. During rotation of the print head activation gear 38, the axially-facing lip 90 selectively engages the stop 60 on the rocker arm assembly 48 within a predetermined angular range of rotation to maintain contact between the teeth of the print head activation gear 38 and the rightmost satellite gear 56. In the form shown, the axially-facing lip 90 will engage the stop 60 when the rocker arm assembly 48 has been moved to the forward feed position and has begun to drive the print head activation gear 38. This maintains engagement of the rightmost satellite gear 56 and the print head activation gear 38 until the print head activation gear 38 is rotated to the activated position at which position the brake 84 engages the print head activation gear 38 and the teeth of the rightmost satellite gear 56 have reached the angular toothless section 80 of the print head activation gear 38. The axially-facing lip 90 does not angularly extend into the angular toothless section 80 of the print head activation gear 38, such that stop 60 does not prevent the rocker arm assembly 48 from pivoting from the forward feed position to the reverse feed position when the motor 32 begins to run in the reverse direction.

It should be appreciated that the delay gear 36 provides a sufficient amount of delay such that the arm 30 can be activated or deactivated without the delay gear 36 initiating the feeding via the media feed roller 18 or the platen roller 26. Once the print head 24 has been moved, the delayed portion 46 of the delay gear 36 begins to drive the media feed roller 18 and the platen roller 26 by toothed sections at the ends thereof. In the form shown, in the forward direction, the delay gear 36 rotates counter-clockwise and, therefore, the media feed roller 18 (which is the upper roller of the media feed roller 18 and pressure roller 20 pair) rotates clockwise. An idler gear 92 connects the media feed roller 18 to the platen roller 26, and the idler gear 92 ensures that the platen roller 26 is also rotated in the clockwise direction and at such a rate as to maintain a slight tension on the tube media between the media feed roller 18 and the platen roller 26.

The gear train having been described, the general operation of the tube printer 10 can be traced with sequential reference to FIGS. 3 through 7.

For purposes of this operational description, the tube printer 10 is initially set to the position in FIG. 3. In FIG. 3, the arm 30 is deactivated so that the print head 24 is spaced from the platen roller 26 and the rocker arm assembly 48 is in the reverse feed position. This is the arrangement of the gear train components after the motor 32 has been run in reverse to, for example, remove and replace the media cartridge 14. Accordingly, in FIG. 2, the post 70 of the arm 30 has engaged the cam surface 66 to move the post 70 away from the rotational axis of the print head activation gear 38 such that the arm 30 and the print head 24 are forced into the disengaged position against any biasing force on the arm 30.

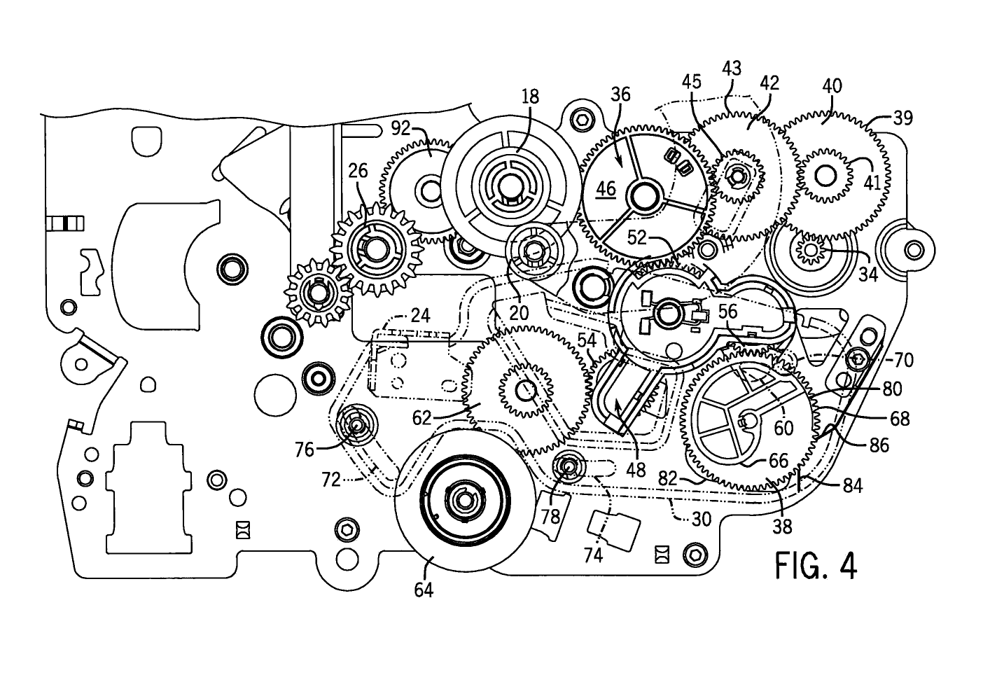

At this point, the motor 32 can be run in a forward direction which, as stated above, is in a clockwise direction. As indicated in FIG. 4, the forward operation of the motor 32 first has the effect of pivoting the rocker arm assembly 48 to the forward feed position in which the leftmost satellite gear 54 is brought into engagement with the ribbon spool idler gear 62 and the rightmost satellite gear 56 is brought into engagement with the print head activation gear 38. At this point, the delay gear 36 only directs the forward motion of the motor 32 through the leg of the gear train directed at the actuation of the arm 30 and print head 24 via the direct-driven portion 44.

As shown in FIG. 5, the further forward motion of the motor 32 causes the rightmost satellite gear 56 to drive the print head activation gear 38 clockwise. This clockwise rotation of the print head activation gear 38 and a biasing force on the arm 30 urges the print head 24 toward the platen roller 26 causing the post 70 to travel radially inwardly along the cam surface 66 toward the center of the print head activation gear 38 until the print head 24 is activated against the platen roller 26 (with tube media and an ink ribbon therebetween).

As noted above, when the arm 30 is moved to the activated position, the rightmost satellite gear 56 approaches the angular toothless section 80 of the print head activation gear 38 and the brake 84 engaging the outwardly-facing non-toothed surface 82 of the print head activation gear 38 to maintain the position of the print head activation gear 38. At this point, no further forward motion is transferred to the print head activation gear 38.

However, the continual forward motion of the motor 32 drives the other gear train components. The continual forward driving of the motor 32 drives the ribbon drive 64 counter-clockwise via the leftmost satellite gear 54 and the ribbon spool idler gear 62 to feed the ink ribbon. Further, after the delay on the delay gear 36 has elapsed, the delayed portion 46 of the delay gear 36 begins to drive the media feed roller 18 in a clockwise direction to feed the tube media between the media feed roller 18 and the pressure roller 20. Moreover, the teeth on the axial end of the media feed roller 18 engages the idler gear 92 which also engages teeth on an axial end of the platen roller 26 to drive the platen roller 26 in clockwise direction.

It should be noted that during the movement of the arm 30 from the deactivated to the activated position, the print head activation gear 38 may attempt to backdrive the rocker arm assembly 48. To avoid separation of the rightmost satellite gear 56 from the print head activation gear 38, shortly after the rightmost satellite gear 56 begins to drive the print head activation gear 38, the stop 60 of the rocker arm assembly 48 engages the axially-facing lip 90 on the print head activation gear 38. This maintains engagement of the rightmost satellite gear 56 and the print head activation gear 38 for the majority of the forward rotation of the print head activation gear 38. However, at the rotational angles of the print head activation gear 38 shown in FIGS. 3 and 5, the axially-facing lip 90 does not engage or restrict the stop 60, such that the rocker arm assembly 48 may pivot relative to the print head activation gear 38 so that either of the two satellite gears 54 and 56 during a change in the direction of operation of the motor 32.

It should also be appreciated that the cam surface 66 is formed with such a profile as to add a dwell time during the activation of the print head 24 toward the platen roller 26 and before the activation is complete. This dwell occurs over the span of the cam surface 66 that is of a generally constant radial distance from the axis of rotation of the print head activation gear 38. By adding the dwell section, the print head 24 is initially moved part way toward the platen roller 36 and then held at this position for a length of time before the cam surface 66 further moves the print head 24 toward the platen roller 26. During this period of dwell, the leftmost satellite gear 54 will continue to drive the ribbon spool idler gear 62 and the ribbon drive 64 to take up slack in the ink ribbon and/or to tighten the ink ribbon before the print head 24 is moved into place. Slack in the ink ribbon of this type may be generated due to operator mishandling of the cartridge or possibly during deactivation of the print head 24. In any event, adding a dwell during activation of the print head 24 by shaping the cam surface 66 accordingly advantageously provides time to remove this slack before activation is complete.

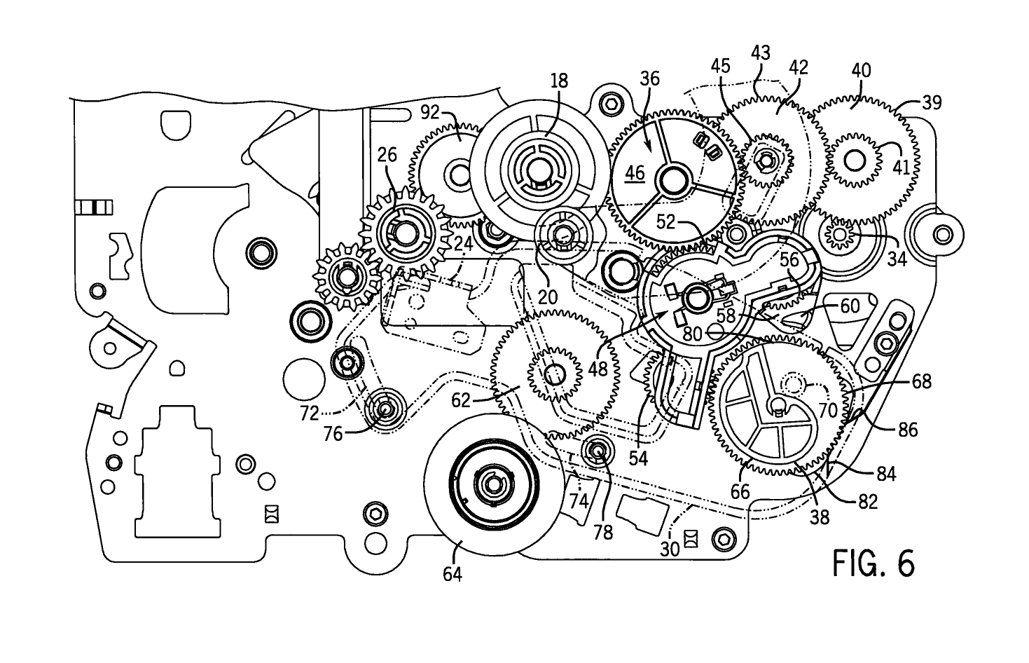

As shown in FIG. 6, when the motor 32 is subsequently driven in a reverse feed direction, the rocker arm assembly 48 pivots to the reverse feed position by the counter-clockwise rotation of the central gear 52. In this position, the rightmost satellite gear 56 is moved clear of the print head activation gear 38 and the leftmost satellite gear 54 engages a toothed portion of the print head activation gear 38. While this pivoting occurs, the brake 84 holds the print head activation gear 38 in its rotational position as the two satellite gears 54 and 56 switch engagement with the print head activation gear 38.

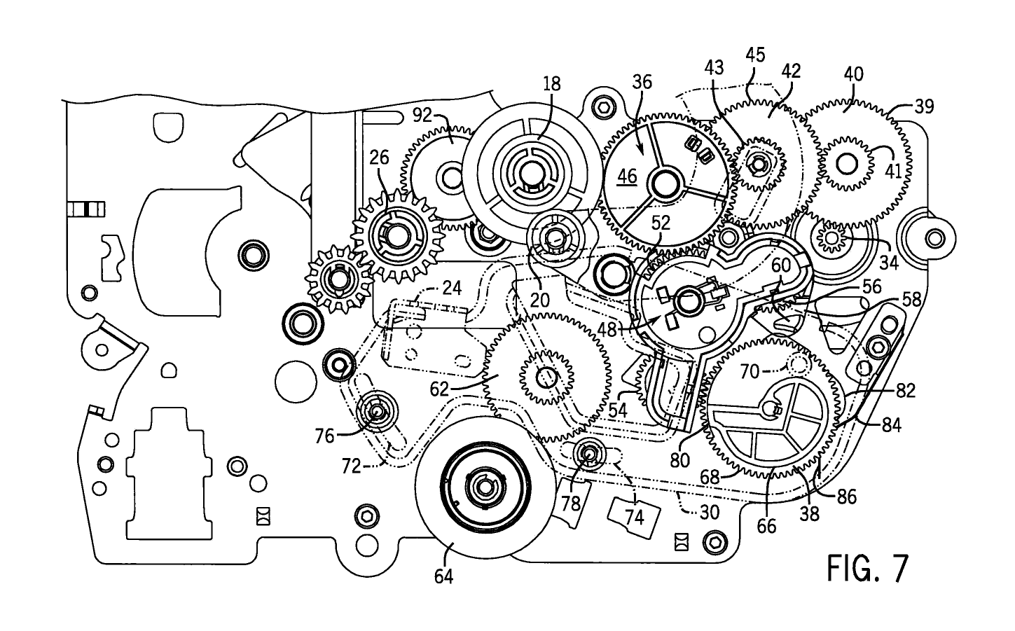

When the motor 32 continues to run in the reverse direction, this causes the leftmost satellite gear 54 to be rotated in a clockwise direction as shown in FIG. 7, which causes the print head activation gear 38 to rotate in a counter-clockwise direction. This counter-clockwise rotation causes the post 70 of the arm 30 to slide away from the rotational axis of the print head activation gear 38 as the post 70 engages the cam surface 66. This movement of the post 70 ultimately moves the arm 30 and the print head 24 thereon to the disengaged position shown in FIG. 3.

As in the movement to the engaged position, the print head activation gear 38 may have a second angular toothless section 94 that prevents further backward driving of the print head activation gear 38 after the arm 30 has been actuated to the disengaged position. As seen in FIGS. 8 through 10, it can be seen that the two satellite gears 54 and 56 and the toothless sections 80 and 94 may be located on different levels such that different rotational stop positions may be defined based on the forward or backward direction of rotation (and the level of the satellite gear that engages the print head activation gear 38).

In the reverse direction, as with the forward direction, once the arm 30 actuation is complete (in the case of the reverse direction, the arm 30 is moved to the deactivated position), the delay gear 36 begins to drive the media feed roller 18 and the platen roller 26, albeit in a reverse direction. In some configurations, the platen roller 26 may have a clutch installed therein so that the platen roller 26 does not rotate at a rate greater than the media feed roller 18 and in such a manner as to create bunching of the reverse fed tube media in the media path.

Thus, a tube printer is disclosed that first actuates the print head and then further operates the feed mechanism. All of this is done with a single motor that drives the disclosed gear train having two separate legs.

Many modifications and variations to this preferred embodiment will be apparent to those skilled in the art, which will be within the spirit and scope of the invention. Therefore, the invention should not be limited to the described embodiment. To ascertain the full scope of the invention, the following claims should be referenced.

What is claimed is:

1. A printer for printing on tube media, the printer comprising:
a platen roller;
a print head supported by an arm, the arm actuatable between an activated position in which the print head is urged toward the platen roller to provide a force therebetween and a deactivated position in which the print head is moved away from the platen roller;
a media feed roller; and
a motor coupled to the arm and the media feed roller, the motor selectively actuating the arm between the activated position and the deactivated position and further driving the media feed roller.

2. The printer of claim 1, wherein the motor is coupled to the arm and the media feed roller by a gear train.

3. The printer of claim 2, wherein the gear train includes a delay gear that initially actuates the arm and, after a delay, drives the media feed roller.

4. The printer of claim 3, wherein the delay gear is configured to generate a delay having a duration that permits completion of an actuation of the arm before driving the media feed roller.

5. The printer of claim 2, wherein a rocker arm assembly operably links the motor to a print head activation gear that actuates the arm.

6. The printer of claim 5, wherein the rocker arm assembly includes a central gear separately intermeshing with two satellite gears.

7. The printer of claim 6, wherein the rocker arm assembly is pivotable between a forward feed position, in which a first gear of the two satellite gears drives the print head activation gear to move the arm into the activated position, and a reverse feed position, in which a second gear of the two satellite gears engages and drives the print head activation gear to move the arm into the deactivated position.

8. The printer of claim 7, wherein, in the reverse feed position, the first gear of the two satellite gears disengages the print head activation gear.

9. The printer of claim 7, wherein, in the forward feed position, the second gear of the two satellite gears engages and drives a ribbon spool.

10. The printer of claim 7, wherein the print head activation gear includes a plurality of radially outward extending teeth located about a circumference of the gear and wherein at least a portion of the circumference does not have teeth.

11. The printer of claim 10, wherein the portion of the circumference of the print head activation gear that does not have teeth is positioned such that, during activation of the arm, as the arm approaches the activated position, the first gear of the two satellite gears reaches the portion of the circumference of the print head activation gear that does not have teeth, thereby preventing further forward driving of the print head activation gear.

12. The printer of claim 11, wherein the printer further comprises a brake that engages the print head activation gear when the arm approaches the activated position.

13. The printer of claim 12, wherein the print head activation gear includes an outwardly-facing non-toothed surface that engages the brake to maintain the printer activation gear in place and thereby preventing the portion of the circumference that does not have teeth from slipping and an end tooth on one side of the portion of the circumference does not have teeth from repetitively engaging the first gear of the two satellite gears and generating noise.

14. The printer of claim 7, wherein the rocker arm assembly further includes a stop and the print head activation gear includes an axially-facing lip.

15. The printer of claim 14, wherein, when the rocker arm assembly is moved to the forward feed position and the first gear drives the print head activation gear to actuate the arm to the activated position, the stop on the rocker arm assembly is configured to engage the axially-facing lip on the print head activation gear thereby maintaining the position of an axis of rotation of the first gear of the two satellite gears relative to an axis of rotation of the print head activation gear.

16. The printer of claim 5, wherein the print head activation gear includes a cam surface and the arm includes a projection that contacts the cam surface and wherein an interaction of the cam surface with the projection during rotation of the print head activation gear causes actuation of the arm.

17. The printer of claim 16, wherein the cam surface has a profile that generates a dwell time during activation of the print head toward the platen roller in which the print head is held in position apart from the platen roller before activation is complete and wherein, during the dwell time, a ribbon drive is rotated to take up slack in an ink ribbon.

18. A method of operating a printer for printing on tube media, the method comprising:
operating a motor that drives a gear train;
actuating an arm supporting a print head via the gear train, the arm being actuated between an activated position in which the print head is urged toward a platen roller to provide a force therebetween and a deactivated position in which the print head is moved away from the platen roller; and
driving a media feed roller via the gear train.

19. The method of claim 18, wherein a delay gear in the gear train first drives actuation of the arm and, only after actuation of the arm is complete, does the delay gear in the gear train drive the media feed roller.

20. The method of claim 18, wherein a single motor both drives actuation of the arm and drives the media feed roller.
